(19) United States
(12) Patent Application Publication
(10) Pub. No.: US 2013/0145907 A1
(43) Pub. Date: Jun. 13, 2013

(54) Adjustable Wrench

(71) Applicant: Etsuo Takenaka, Higashi-Osaka-city (JP)

(72) Inventor: Etsuo Takenaka, Higashi-Osaka-city (JP)

(73) Assignee: LOBTEX CO., LTD., Higashi-Osaka-City (JP)

(21) Appl. No.: 13/695,188

(22) PCT Filed: Mar. 29, 2011
(86) PCT No.: PCT/JP2011/057889

§ 371 Date: Oct. 29, 2012

(30) Foreign Application Priority Data
Apr. 30, 2010 (JP) 2010-105237

(51) Int. Cl. B25B 13/16

(52) U.S. Cl. CPC B25B 13/16
USPC 81/170; 81/129

(57) ABSTRACT

The present invention provides an adjustable wrench which can suppress backlash or clearance play of a movable body with respect to a main body in all directions orthogonal to a direction in which a pair of jaws come into contact with and separate from each other. An adjustable wrench further includes first urging means that urges a columnar portion such that the columnar portion is held in a state in which an axis of the columnar portion crosses an axis of a guide hole portion at an inclined angle in each of both a direction from the axis toward an open portion in the guide hole portion and a direction orthogonal to the above direction and the axis of the guide hole portion.

### TECHNICAL FIELD

The present invention relates to an adjustable wrench including a main body having a fixed jaw, and a movable body having a movable jaw that comes into contact with and separates from the fixed jaw in a predetermined contact and separation direction.

### BACKGROUND ART

Conventionally, as an adjustable wrench (also called “adjustable spanner”) including a main body having a fixed jaw, and a movable body having a movable jaw that comes into contact with and separates from the fixed jaw in a predetermined contact and separation direction, an adjustable wrench in which a columnar portion that is inserted into a guide hole portion of the main body and guided in the contact and separation direction, and urging means that urges the columnar portion are provided in the movable body has been known (e.g., Patent Document 1). In the adjustable wrench as described above, the urging means urges the movable body such that distal end portions of the pair of jaws separate from each other.

### CITATION LIST

### Patent Document

Patent Document 1:

Japanese Patent Laid-Open No. 2004-42240

### SUMMARY OF INVENTION

### Technical Problem

Meanwhile, in the adjustable wrench according to Patent Document 1, the urging means urges the movable body, so that backlash or clearance play of the movable body with respect to the main body can be suppressed in a predetermined direction in which the distal end portion of the movable jaw separates from the distal end portion of the fixed jaw. However, the adjustable wrench as described above cannot always suppress the backlash or clearance play of the movable body with respect to the main body in a direction other than the predetermined direction, i.e., all directions orthogonal to the direction in which the pair of jaws come into contact with and separate from each other.

Thus, based on such circumstances, it is an object of the present invention to provide an adjustable wrench which can suppress backlash or clearance play of a movable body with respect to a main body in all directions orthogonal to a direction in which a pair of jaws come into contact with and separate from each other.

### Solution to Problem

An adjustable wrench according to the present invention includes a main body having a fixed jaw, and a movable body having a movable jaw that comes into contact with and separates from the fixed jaw in a predetermined contact and separation direction, the movable body being relatively displaced with respect to the main body in the contact and separation direction such that the pair of jaws come into contact with and separate from each other, the main body including a guide hole portion whose axis is arranged along the contact and separation direction and that guides the movable body, the movable body including a columnar portion that is inserted into the guide hole portion so as to be guided in the guide hole portion, and the guide hole portion including along the contact and separation direction an open portion through which the movable jaw provided projecting from the columnar portion penetrates, the adjustable wrench further including first urging means that urges the columnar portion such that the columnar portion is held in a state in which an axis of the columnar portion crosses the axis of the guide hole portion at an inclined angle in each of both a direction from the axis toward the open portion in the guide hole portion and a direction orthogonal to the above direction and the axis of the guide hole portion.

With the adjustable wrench according to the present invention, the first urging means urges the columnar portion, so that the columnar portion is held in a state in which the axis of the columnar portion crosses the axis of the guide hole portion at an inclined angle in each of both the direction from the axis toward the open portion in the guide hole portion and the direction orthogonal to the above direction and the axis of the guide hole portion. Accordingly, backlash or clearance play of the movable body with respect to the main body can be suppressed in all radial directions of the columnar portion.

Also, the adjustable wrench according to the present invention may be configured so that the adjustable wrench further includes a worm that is rotated about the contact and separation direction so as to displace the movable body with respect to the main body, wherein the columnar portion includes a plurality of plate-like portions that are arranged along an axial direction to mesh with the worm, and the plurality of plate-like portions are respectively arranged so as to cross the axial direction of the columnar portion, and is set such that the respective portions have such an interval that both surfaces of at least one of the plate-like portions come into abutment against the worm when the columnar portion is urged by the first urging means.

With the adjustable wrench having the configuration as described above, when the worm is rotated about the contact and separation direction, the plurality of plate-like portions arranged along the axial direction mesh with the worm, so that the movable body is displaced with respect to the main body. When the columnar portion is urged by the first urging means, the both surfaces of at least one plate-like portion out of the plurality of plate-like portions set such that the respective portions have the predetermined interval therebetween come into abutment against the worm. Accordingly, the backlash or clearance play of the movable body with respect to the main body can be also suppressed in the axial direction of the columnar portion.

Also, in the adjustable wrench according to the present invention, the adjustable wrench may further include second urging means that urges the worm in the contact and separation direction.

With the adjustable wrench having the configuration as described above, since the second urging means urges the worm in the contact and separation direction, backlash or clearance play of the worm with respect to the main body in the contact and separation direction can be suppressed. Accordingly, since the both surfaces of at least one plate-like portion abut against the worm, the backlash or clearance play of the movable body with respect to the main body can be more reliably suppressed in the axial direction of the columnar portion.

### Advantageous Effect of Invention

As described above, with the adjustable wrench according to the present invention, the backlash or clearance play of the movable body with respect to the main body can be suppressed in all the radial directions of the columnar portion, so that there is obtained an excellent effect that the backlash or clearance play of the movable body with respect to the main body can be suppressed in all directions orthogonal to the direction in which the pair of jaws come into contact with and separate from each other.

### BRIEF DESCRIPTION OF DRAWINGS

FIG. 1 are overall views of an adjustable wrench according to one embodiment of the present invention: FIG. 1(a) is a plan view; and FIG. 1(b) is a plan view.

FIG. 2 are main portion enlarged views of the adjustable wrench according to the same embodiment: FIG. 2(a) is a sectional view taken along a line B-B of FIG. 1(b); and FIG. 2(b) is a sectional view taken along a line D-D of FIG. 2(a).

FIG. 3 are main portion enlarged views of the adjustable wrench according to the same embodiment: FIG. 3(a) is a sectional view taken along a line E-E of FIG. 2(a); and FIG. 3(b) is a front view.

FIG. 4 are main portion enlarged views for explaining respective axial positions and respective contact point positions of the adjustable wrench according to the same embodiment: FIG. 4(a) is a sectional view taken along a line B-B of FIG. 1(b); and FIG. 4(b) is a sectional view taken along a line D-D of FIG. 2(a).

FIG. 5 are main portion enlarged views for explaining respective axial positions and respective contact point positions of the adjustable wrench according to the same embodiment: FIG. 5(a) is a sectional view taken along a line E-E of FIG. 2(a); and FIG. 5(b) is a front view.

FIG. 6 are main portion enlarged views for explaining respective contact point positions of an adjustable wrench according to another embodiment of the present invention: FIG. 6(a) is a horizontal sectional view; FIG. 6(b) is a vertical sectional view; and FIG. 6(c) is a front view.

FIG. 7 are main portion enlarged views of an adjustable wrench according to still other embodiments of the present invention: FIG. 7(a) is a vertical sectional view; and FIG. 7(b) is a horizontal sectional view.

### DESCRIPTION OF EMBODIMENTS

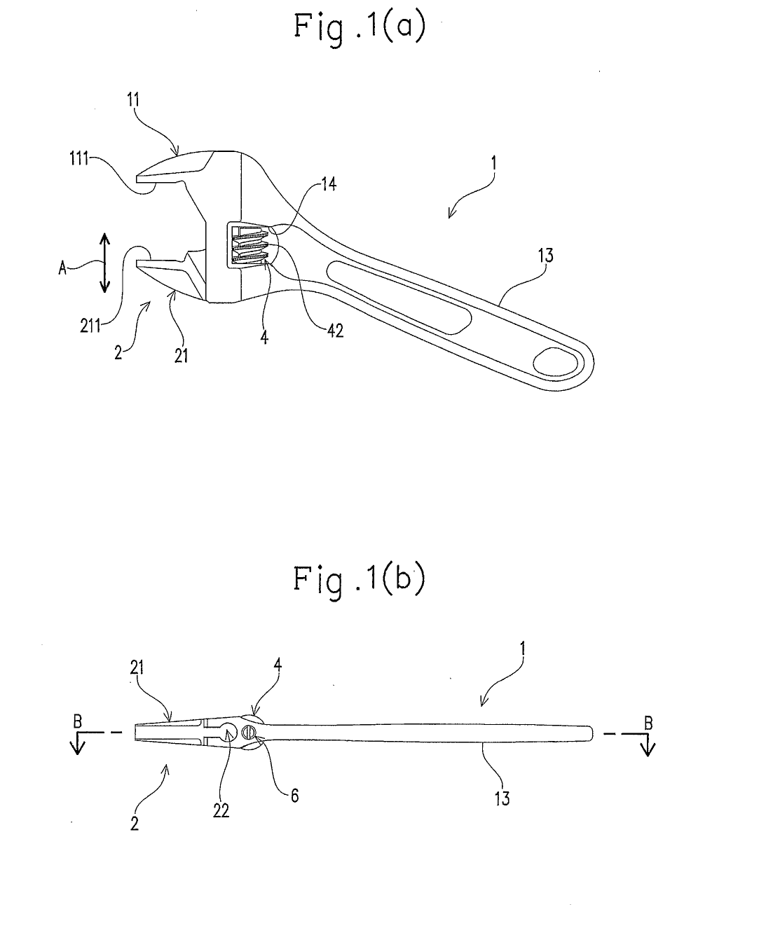

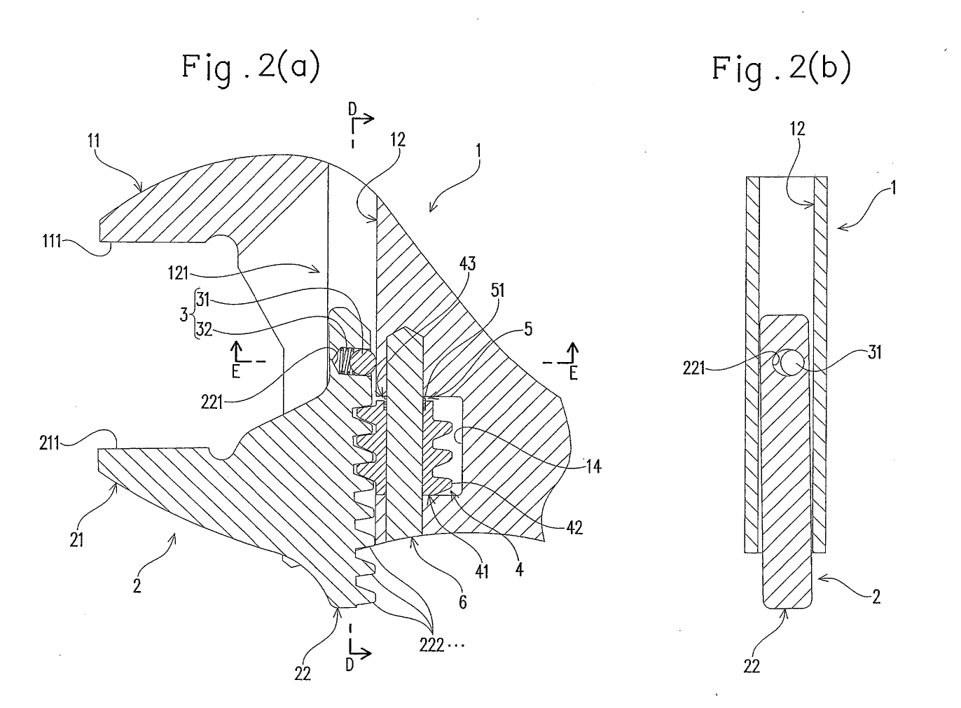

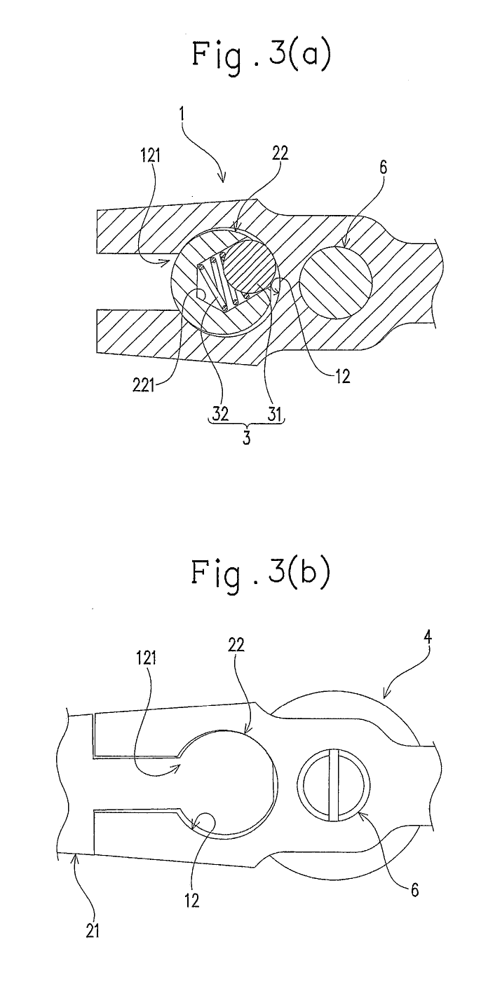

In the following, one embodiment of an adjustable wrench according to the present invention will be described by reference to FIGS. 1 to 5.

The adjustable wrench according to the present embodiment includes a plate-like main body 1 having a fixed jaw 11 at a distal end portion, and a plate-like movable body 2 having a movable jaw 21 as shown in FIGS. 1 to 3. In the adjustable wrench, the movable body 2 is relatively displaced with respect to the main body 1 in a predetermined direction (the direction of an arrow A in FIG. 1(a), referred to as “contact and separation direction” below), so that the fixed jaw 11 and the movable jaw 21 come into contact with and separate from each other in the contact and separation direction.

The adjustable wrench also includes first urging means 3 that urges the movable body 2. The adjustable wrench further includes a worm 4 that is rotated about the contact and separation direction so as to be operated to displace the movable body 2 with respect to the main body 1, and second urging means 5 that urges the worm 4 in the contact and separation direction.

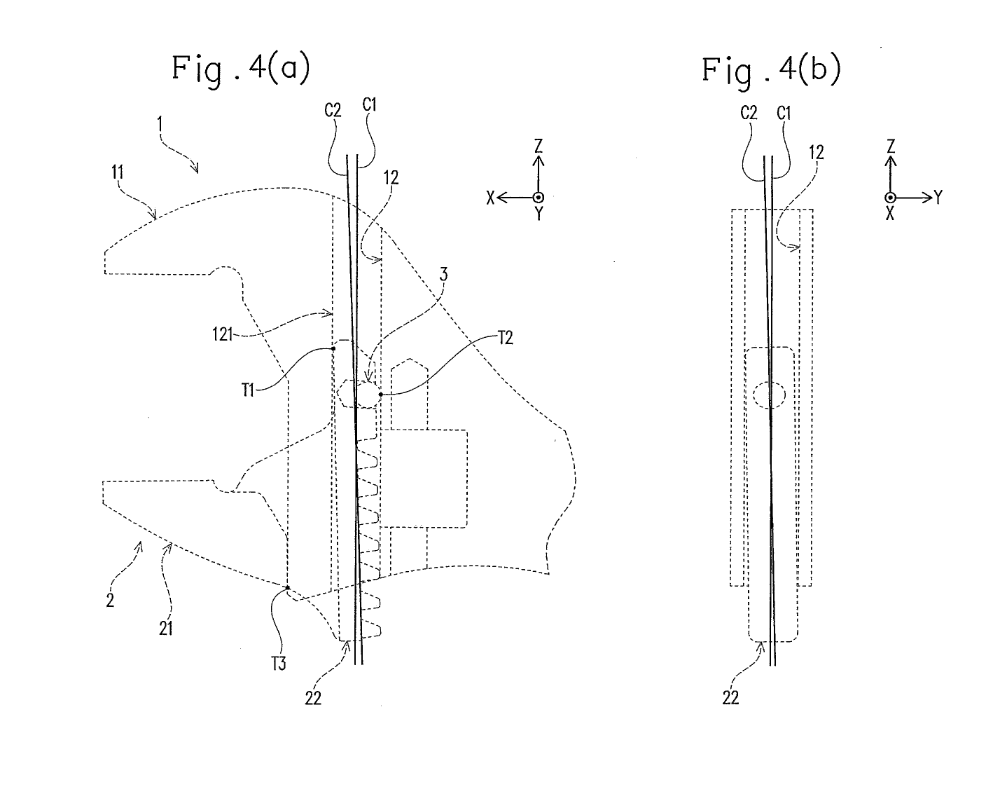

The main body 1 includes a guide hole portion 12 whose axis C1 (see FIG. 4) is arranged along the contact and separation direction and that guides the movable body 2. The main body 1 also includes a grip handle 13 that extends in an opposite direction to the fixed jaw 11 to be gripped, and a window hole 14 in which the worm 4 is arranged.

The fixed jaw 11 includes a first holding surface 111 that holds an object such as a bolt and a nut with the movable jaw 21. The first holding surface 111 is arranged orthogonal to the contact and separation direction, i.e., orthogonal to the axis C1 of the guide hole portion 12.

The guide hole portion 12 is formed in a perfect circular shape, and an open portion 121 that opens one circumferential portion such that the movable jaw 21 penetrates into the guide hole portion 12 is provided in the guide hole portion 12. The open portion 121 is arranged along the contact and separation direction such that the movable jaw 21 passes in the contact and separation direction when the movable body 2 is displaced with respect to the main body 1 in the contact and separation direction.

The movable body 2 includes a substantially-cylindrical columnar portion 22 that is slidably inserted into the guide hole portion 12. The movable jaw 21 is provided projecting in a flat plate-like shape from an outer circumferential portion of the columnar portion 22. That is, a proximal end portion of the movable jaw 21 is arranged along an axial direction of the columnar portion 22, and is coupled to the outer circumferential portion of the columnar portion 22.

The movable jaw 21 includes a second holding surface 211 that holds an object with the first holding surface 111 of the fixed jaw 11. The second holding surface 211 is arranged so as to cross an axis C2 (see FIG. 4) of the columnar portion 22 at an inclined angle.

The columnar portion 22 includes a concave accommodation portion 221 that accommodates the first urging means 3 on an opposite side to a side to which the movable jaw 21 projects in the outer circumferential portion (simply referred to as “opposite side” below). The columnar portion 22 also includes a plurality of (seven in the present embodiment) plate-like portions 222 that are arranged along the axial direction on the opposite side of the outer circumferential portion to the movable jaw 21.

The plate-like portions 222 mesh with an outer circumferential portion of the worm 4. The plate-like portions 222 are arranged parallel to each other, and are also arranged so as to cross the axis C2 of the columnar portion 22 at an inclined angle. The plate-like portions 222 are also set such that the respective portions have a predetermined interval therebetween. To be more specific, the interval between the respective portions is set such that both surfaces of at least one plate-like portion 222 come into abutment against the worm 4 when the columnar portion 22 is urged by the first urging means 3.

The first urging means 3 includes a spherical abutment member 31 that abuts against an inner circumferential portion of the guide hole portion 12 of the main body 1, and a cylindrical first elastic body 32 that is arranged between the abutment member 31 and the columnar portion 22. In the first urging means 3, at least one portion of the abutment member 31 and the first elastic body 32 are accommodated in the accommodation portion 221 of the columnar portion 22, so that the abutment member 31 is guided in the guide hole portion 12, and the first urging means 3 is displaced integrally with the columnar portion 22 (the movable body 2) with respect to the main body 1.

The first urging means 3 also urges the columnar portion 22 in a direction to cross the flat plate-like movable jaw 21 at an inclined angle. The first urging means 3 further urges the columnar portion 22 in a direction to cross a (virtual) surface orthogonal to the axis C2 of the columnar portion 22 at an inclined angle. In addition, the first urging means 3 urges one axial end side (the fixed jaw 11 side) of the columnar portion 22.

The worm 4 includes a cylindrical worm main body 41 that is inserted onto a shaft 6 fixed to the main body 1, and a mesh portion 42 that is arranged in a spiral manner at the outer circumferential portion of the worm main body 41 to mesh with the plate-like portions 222 of the columnar portion 22. The worm 4 also includes a concave portion 43 that accommodates the second urging means 5 on one end side of the worm main body 41. The shaft 6 is arranged with its axis along the contact and separation direction.

The second urging means 5 includes a second elastic body 51 that is arranged on one axial end side (the fixed jaw 11 side) of the worm 4 between the main body 1 and the worm 4. The second elastic body 51 is formed in a cylindrical shape, and is inserted onto the shaft 6.

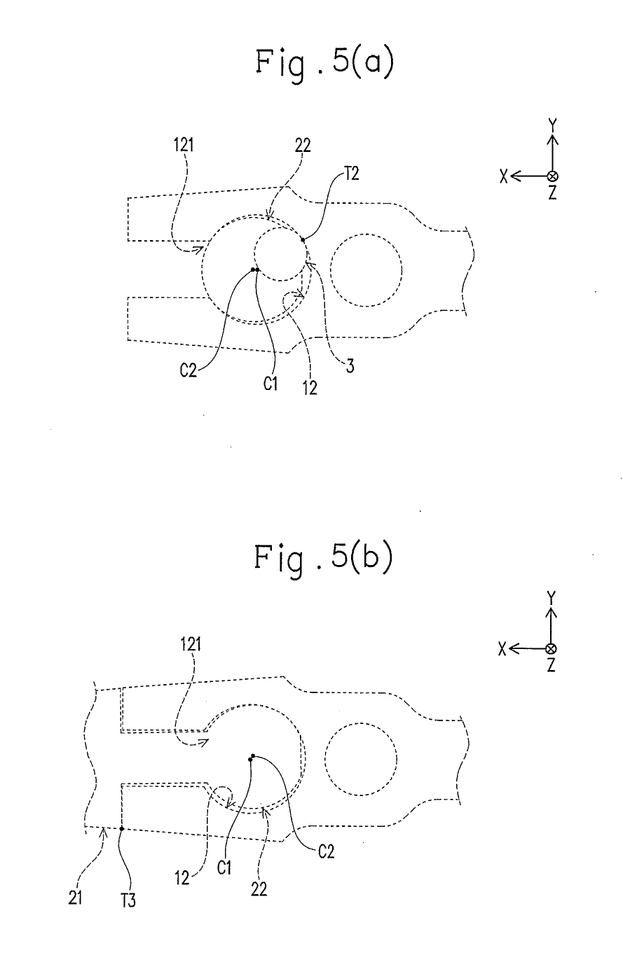

In the following, for the convenience of description, a direction from the axis C1 toward the open portion 121 in the guide hole portion 12, and also orthogonal to the axis C1 of the guide hole portion 12 is referred to as “X direction”, a direction orthogonal to the X direction, and also orthogonal to the axis C1 of the guide hole portion 12 is referred to as “Y direction”, and a direction parallel to the axis C1 of the guide hole portion 12 is referred to as “Z direction” as shown in FIGS. 4 and 5.

In the adjustable wrench according to the present embodiment having the configuration as described above, the first urging means 3 urges the columnar portion 22 in an axial direction of the cylindrical first elastic body 32. To be more specific, the first urging means 3 urges the columnar portion 22 in the direction to cross the flat plate-like movable jaw 21 at an inclined angle, and to also cross the (virtual) surface orthogonal to the axis C2 of the columnar portion 22 at an inclined angle. The axis C2 of the columnar portion 22 thereby crosses the axis C1 of the guide hole portion 12 at an inclined angle in the X and Y directions as shown in FIGS. 4 and 5.

In other words, the axis C2 of the columnar portion 22 crosses each of a (virtual) surface (a YZ plane) orthogonal to the direction from the axis C1 toward the open portion 121 in the guide hole portion 12, and a (virtual) surface (an XY plane) orthogonal to the axis C1 of the guide hole portion 12 at an inclined angle. The axis C2 of the columnar portion 22 also crosses a (virtual) surface (a ZX plane) parallel to the direction from the axis C1 toward the open portion 121 in the guide hole portion 12, and also parallel to the axis C1 of the guide hole portion 12 at an inclined angle.

Accordingly, on the one axial end side (the fixed jaw 11 side) of the columnar portion 22, the outer circumferential portion of the columnar portion 22 on the side to which the movable jaw 21 projects (simply referred to as “projection side” below) and the abutment member 31 come into abutment against the inner circumferential portion of the guide hole portion 12, and on the other axial end side (the movable jaw 21 side) of the columnar portion 22, the proximal end side of the movable jaw 21 comes into abutment against the open portion 121 side of the guide hole portion 12.

As a result, the columnar portion 22 is held in a state in which the axis C1 of the guide hole portion 12 and the axis C2 of the columnar portion 22 cross each other at an inclined angle in each of the X and Y directions, so that backlash or clearance play of the movable body 2 with respect to the main body 1 can be suppressed in all radial directions of the columnar portion 22. Therefore, the backlash or clearance play of the movable body 2 with respect to the main body 1 can be suppressed in all directions orthogonal to the direction in which the pair of jaws 11 and 21 come into contact with and separate from each other.

In FIGS. 4 and 5, a contact point where the outer circumferential portion of the columnar portion 22 on the projection side and the inner circumferential portion of the guide hole portion 12 abut against each other is shown as T1, a contact point where the abutment member 31 and the inner circumferential portion of the guide hole portion 12 abut against each other is shown as T2, and a contact point where the proximal end side of the movable jaw 21 and the open portion 121 side of the guide hole portion 12 abut against each other is shown as T3.

Also, in the adjustable wrench according to the present embodiment, the first urging means 3 urges the columnar portion 22 from the one axial end side (the fixed jaw 11 side) of the columnar portion 22 and the opposite side of the outer circumferential portion of the columnar portion 22. Accordingly, the columnar portion 22 is urged and held in a state in which a distal end portion of the movable jaw 21 separates from a distal end portion of the fixed jaw 11.

Here, when an operator applies a force to the adjustable wrench so as to hold an object between the pair of jaws 11 and 21, the force acts in a direction in which the pair of jaws 11 and 21 separate from each other. Thus, even when an operator applies a force to the adjustable wrench after adjusting a separation distance between the pair of jaws 11 and 21, the backlash or clearance play (displacement) of the movable body 2 with respect to the main body 1 against an urging force of the first urging means 3 can be prevented.

Also, in the adjustable wrench according to the present embodiment, the columnar portion 22 is urged by the first urging means 3, so that the both surfaces of the plate-like portions 222 meshing with the mesh portion 42 of the worm 4 come into abutment against the mesh portion 42 of the worm 4. Accordingly, the backlash or clearance play of the movable body 2 with respect to the main body 1 can be suppressed not only in the radial directions of the columnar portion 22 but also in the axial direction of the columnar portion 22.

Also, in the adjustable wrench according to the present embodiment, the second urging means 5 urges the worm 4 in the contact and separation direction, so that backlash or clearance play of the worm 4 with respect to the main body 1 in the contact and separation direction can be suppressed. Accordingly, since the both surfaces of the plate-like portions 222 meshing with the mesh portion 42 of the worm 4 abut against the mesh portion 42 of the worm 4, the backlash or clearance play of the movable body 2 with respect to the main body 1 can be more reliably suppressed in the axial direction of the columnar portion 22.

Also, in the adjustable wrench according to the present embodiment, the second holding surface 211 of the movable jaw 21 is arranged so as to cross the axis C2 of the columnar portion 22 at an inclined angle. Therefore, when the columnar portion 22 is urged by the first urging means 3, the axis C2 of the columnar portion 22 crosses the axis C1 of the guide hole portion 12 at an inclined angle in the X and Y directions, so that the first holding surface 111 of the fixed jaw 11 and the second holding surface 211 of the movable jaw 21 are arranged parallel to each other.

Please note that the adjustable wrench according to the present invention is not limited to the aforementioned embodiment, and of course, various changes may be made therein without departing from the scope of the present invention. It also goes without saying that any of a configuration, a method or the like according to various modifications described below may be selected and applied to the configuration, the method or the like according to the aforementioned embodiment.

For example, in the adjustable wrench according to the aforementioned embodiment, the case in which the columnar portion 22 is held when the main body 1 and the movable body 2 abut against each other at the contact point T1 between the outer circumferential portion of the columnar portion 22 on the projection side and the inner circumferential portion of the guide hole portion 12, the contact point T2 between the abutment member 31 and the inner circumferential portion of the guide hole portion 12, and the contact point T3 between the proximal end side of the movable jaw 21 and the open portion 121 side of the guide hole portion 12 has been described. However, the present invention is not limited thereto.

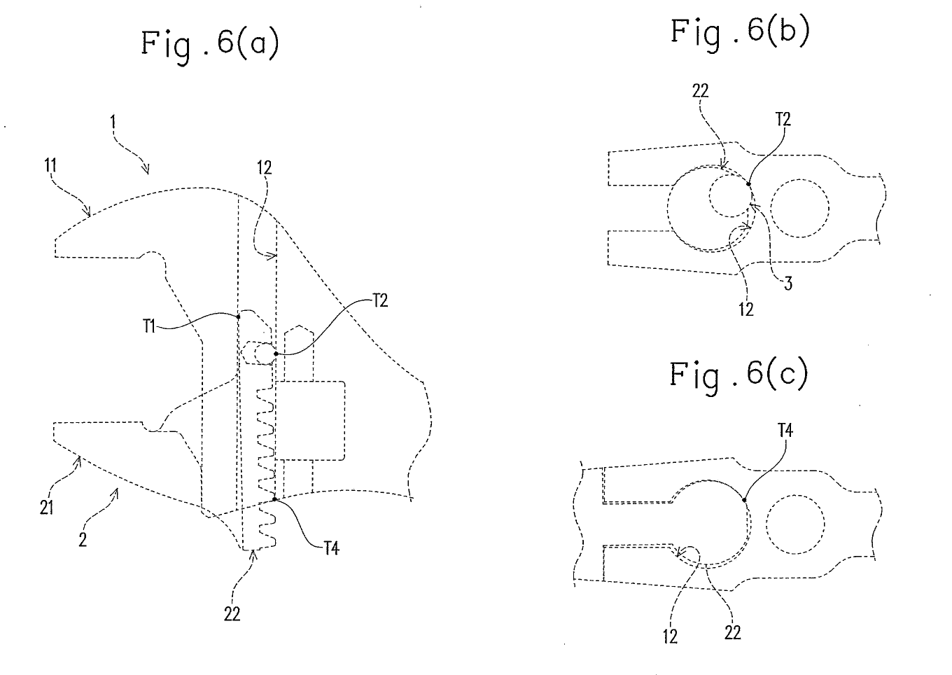

To be more specific, on one axial end side (the movable jaw 21 side) of the columnar portion 22, the outer circumferential portion of the columnar portion 22 on the opposite side and the inner circumferential portion of the guide hole portion 12 abut against each other at a contact point T4 instead of the contact point T3 as shown in FIG. 6, so that the columnar portion 22 may be held when the main body 1 and the movable body 2 abut against each other at the contact points T1, T2 and T4.

Also, in the adjustable wrench according to the aforementioned embodiment, the case in which the first urging means 3 urges the columnar portion 22 in the direction to cross the flat plate-like movable jaw 21 at an inclined angle, and to also cross the (virtual) surface orthogonal to the axis C2 of the columnar portion 22 at an inclined angle has been described. However, the present invention is not limited thereto.

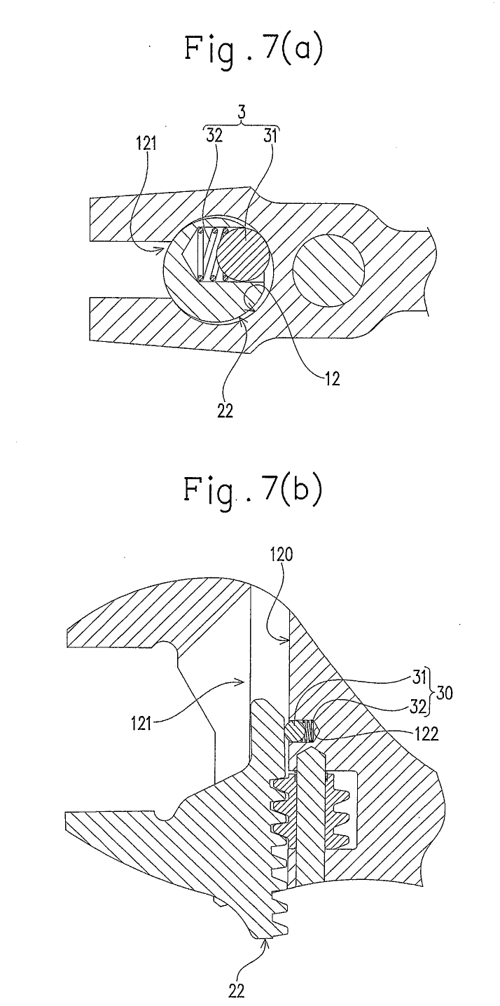

For example, as shown in FIG. 7(a), the first urging means 3 may urge the columnar portion 22 at a position apart from the axis C2 of the columnar portion 22 in a direction parallel to the flat plate-like movable jaw. In short, the first urging means may be arranged so as to urge the columnar portion 22 such that the columnar portion 22 is held in a state in which the axis C2 of the columnar portion 22 crosses the axis C1 of the guide hole portion 12 at an inclined angle in each of both the direction from the axis C1 to the open portion 121 in the guide hole portion 12 (the X direction) and the direction orthogonal to the above direction and the axis C1.

Also, in the adjustable wrench according to the aforementioned embodiment, the case in which the accommodation portion 221 that accommodates at least one portion of the abutment member 31 and the first elastic body 32 is provided in the columnar portion 22 has been described. However, the present invention is not limited thereto.

For example, as shown in FIG. 7(b), an accommodation portion 122 that accommodates at least one portion of the abutment member 31 and the first elastic body 32 may be provided in a guide hole portion 120. First urging means 30 shown in FIG. 7(b) includes the spherical abutment member 31 that abuts against the outer circumferential portion of the columnar portion 22, and the cylindrical first elastic body 32 that is arranged between the abutment member 31 and the guide hole portion 120.

Also, in the adjustable wrench according to the aforementioned embodiment, the case in which the first urging means 3 includes the spherical abutment member 31 and the cylindrical first elastic body (a spring, a coil spring) 32 has been described. However, the present invention is not limited thereto, and for example, the first urging means may include a plate-like elastic body (a leaf spring). In short, the first urging means may urge the columnar portion 22 in a predetermined direction.

Also, in the adjustable wrench according to the aforementioned embodiment, the case in which the second urging means 5 includes the cylindrical second elastic body (a spring, a coil spring) 51 has been described. However, the present invention is not limited thereto, and for example, the second urging means may include a plate-like elastic body (a leaf spring). In short, the second urging means may urge the worm in the contact and separation direction.

Also, in the adjustable wrench according to the aforementioned embodiment, the case in which the first urging means 3 includes the single abutment member 31 and the single first elastic body 32 has been described. However, the present invention is not limited thereto. For example, the first urging means may include a plurality of spherical abutment members 31 and a plurality of cylindrical first elastic bodies 32, which may urge the columnar portion 22 respectively at different positions or in different directions.

### REFERENCE SIGNS LIST

1: Main body, 2: Movable body, 3: First urging means, 4: Worm, 5: Second urging means, 11: Fixed jaw, 12: Guide hole portion, 22: Columnar portion, 121: Open portion, 222: Plate-like portion, C1: Axis (of the guide hole portion), C2: Axis (of the columnar portion)

1. An adjustable wrench comprising a main body having a fixed jaw, and a movable body having a movable jaw that comes into contact with and separates from the fixed jaw in a predetermined contact and separation direction, the movable body being relatively displaced with respect to the main body in the contact and separation direction such that the pair of jaws come into contact with and separate from each other,
the main body including a guide hole portion whose axis is arranged along the contact and separation direction and that guides the movable body,
the movable body including a columnar portion that is inserted into the guide hole portion so as to be guided in the guide hole portion, and
the guide hole portion including along the contact and separation direction an open portion through which the movable jaw provided projecting from the columnar portion penetrates,
the adjustable wrench further comprising first urging means that urges the columnar portion such that the columnar portion is held in a state in which an axis of the columnar portion crosses the axis of the guide hole portion at an inclined angle in each of both a direction from the axis toward the open portion in the guide hole portion and a direction orthogonal to the above direction and the axis of the guide hole portion.

2. The adjustable wrench according to claim 1, further comprising a worm that is rotated about the contact and separation direction so as to displace the movable body with respect to the main body,
wherein the columnar portion includes a plurality of plate-like portions that are arranged along an axial direction to mesh with the worm, and
the plurality of plate-like portions are respectively arranged so as to cross the axial direction of the columnar portion, and are set such that the respective portions have such an interval that both surfaces of at least one of the plate-like portions come into abutment against the worm when the columnar portion is urged by the first urging means.

3. The adjustable wrench according to claim 2, further comprising second urging means that urges the worm in the contact and separation direction.
